(19) United States
(12) Patent Application Publication
(10) Pub. No.: US 2025/0160510 A1
(43) Pub. Date: May 22, 2025

(54) Multifunctional Guitar Practice Table

(71) Applicant: Maolin Zhao, Shenzhen (CN)

(72) Inventor: Maolin Zhao, Shenzhen (CN)

(21) Appl. No.: 18/636,493

(22) Filed: Apr. 16, 2024

(30) Foreign Application Priority Data
Nov. 22, 2023 (CN) 202311574565.6

(51) Int. Cl. A47B 19/00; G10G 5/00

(52) U.S. Cl. CPC A47B 19/002; G10G 5/00; A47B 2019/006

(57) ABSTRACT

The disclosure relates to a multifunctional guitar practice table designed to enhance the utility and convenience of musical practice by integrating several functionalities into a single compact unit. This table combines a guitar stand, a music score stand, and a workspace into one versatile structure, tailored for the needs of guitarists. The primary components include a base body with accommodating spaces for a guitar, a rotatable and inclinable music score plate, and multiple storage shelves. Additional features include a neck placement groove with a locking mechanism for guitar stability, magnetic elements for securing music scores, and handle holes for ease of transport. The multifunctional table addresses the shortcomings of existing single-function stands by offering a streamlined solution for musicians, providing easy access, improved organization, and flexible viewing angles for music scores. This invention promises to simplify the practice environment for guitar players, making it more efficient and user-friendly.

### TECHNICAL FIELD

The present utility model relates to the technical field of peripheral devices for musical instruments, and in particular to a multifunctional guitar practice table.

### BACKGROUND OF THE INVENTION

In the daily practice of guitar, three basic accessories are usually needed, i.e., a stand for placing the guitar, a music stand for placing the music score and a desk for placing metronomes, learning materials and other articles. However, the existing guitar stands, music stands and desks mostly have single functions, and are not convenient for users to use. In view of the above problem, the present invention provides a multifunctional guitar practice table.

### SUMMARY OF THE INVENTION

In view of the shortcoming of low functionality of guitar stands, music stands and desks in the prior art, an objective of the present invention is to a multifunctional guitar practice table (also referred to as a guitar practice table hereinafter), which integrates a guitar stand, a music stand and a desk through an improved design in combination with the daily usage scenarios of a guitar user. To achieve the above objective, the present invention employs the following technical solution. A multifunctional guitar practice table is provided, including a base body, wherein an accommodating portion is arranged between the inner walls of two sides of the base body, and a space in the accommodating portion is used to place a guitar. A guitar supporting rod and a guitar limiting rod are mounted between the inner walls of the base body, and the guitar supporting rod and the guitar limiting rod are used to place and limit the guitar. A neck placement groove and a neck baffle are arranged in an upper portion of the base body. When the guitar is placed on the guitar supporting rod, the guitar limiting rod will abut against the back of the guitar to prevent the backward slippage of the guitar, the neck of the guitar is placed in the neck placement groove, and the neck baffle is buckled on the neck placement groove so as to lock the neck and prevent the neck from displacement. At this time, the guitar can be steadily placed in the accommodating portion.

Music score plate: the music score plate is connected to the top of the base body through a hinge, the music score plate can be used to place a music score or book, and the music score plat can be inclined or laid flat through the hinge, so that it is convenient for a user to view the music score from multiple angles. In the daily state of the guitar practice table, the music score plate can be laid flat, so that the guitar practice table can serve as a desk.

Music score plate baffle: the music score plate baffle is connected to an edge of the music score plate through a hinge. The music score plate can be rotated about the axis of the hinge and laid flat. When the music score plate is an inclined state, the music score plate baffle can be rotated to a certain angle to support an article on the music score plate, so as to prevent the article on the music score plate from sliding off.

Magnets: a number of magnets are embedded inside the music score plate and are used in combination with a magnetic pressing block with magnetism. When the music score is placed on the music score plate, in order to prevent pages from turning arbitrarily, the magnetic pressing block is placed at the position corresponding to the back of the music score to press a page by the magnetism of the upper and lower magnets, so as to prevent the page from turning arbitrarily. Shelves: shelves are arranged in the lower, middle and upper portions of the guitar practice table, and can be used to place other articles so as to provide convenience for guitar learning.

The present invention has the following technical effects.
1. This guitar practice table functions as a guitar stand and can be used to place a guitar, and it is very convenient to place and take out the guitar.
2. This guitar practice table functions as a music stand and can be used to place a music score and other books, and the music stand can be turned over and laid flat and used in combination with the music score plate baffle, so that it is convenient for the user to view the music score from multiple angles. In the daily state of the guitar practice table, the music score plate can be laid flat, so that the guitar practice table can serve as a desk.
3. A number of magnets are embedded inside the music score plate and used in combination with the external magnetic pressing block, so that a page can be conveniently fixed on the music score plate, and the page can be prevented from turning arbitrarily.
4. This guitar practice table is provided with a plurality of shelves to provide a more placement space and facilitate guitar learning.
5. Handle holes are formed on two sides of this guitar practice table, so it is convenient for carrying and moving this guitar practice table.

### BRIEF DESCRIPTION OF THE DRAWINGS

FIGS. 1, 2 and 3 are explanatory diagrams of components of a multifunctional guitar practice table according to the present invention;

FIG. 4 is a stereoscopic view of the multifunctional guitar practice table according to the present invention;

FIGS. 5 and 6 are schematic diagrams of guitar placement of the multifunctional guitar practice table according to the present invention;

FIG. 7 is a schematic diagram of unfolding the music score plate of the multifunctional guitar practice table according to the present invention;

FIG. 8 is a schematic diagram of laying the music score plate of the multifunctional guitar practice table flat according to the present invention; and

FIG. 9 is a function diagram of placing the guitar and the music score on the multifunctional guitar practice table according to the present invention;

in which: 1: base body; 2: guitar accommodating portion; 3: guitar supporting rod; 4: guitar limiting rod; 5: music score plate; 6: music score baffle; 7: neck placement groove; 8: neck baffle; 9: neck baffle axis; 10: hinge; 11: magnet; 12: bottom shelf; 13: middle shelf; 14: top shelf; 15: handle hole; and, 16: magnetic pressing block.

### DETAILED DESCRIPTION OF THE SEVERAL EMBODIMENTS

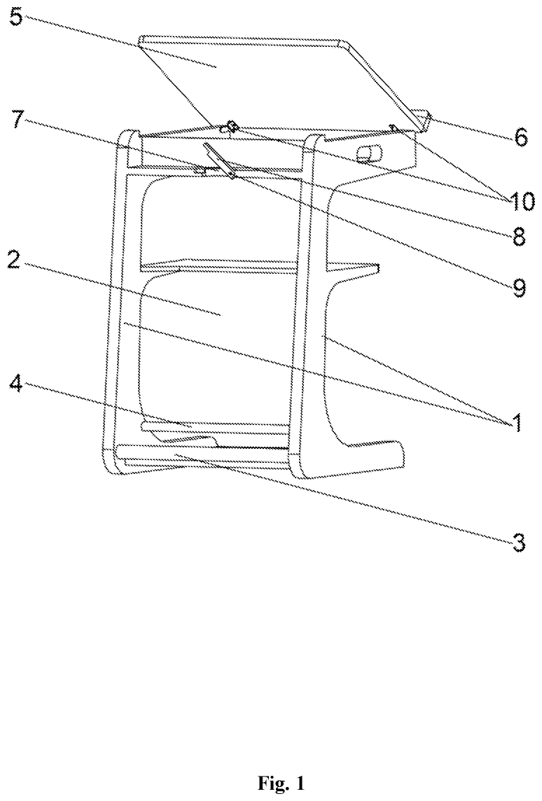

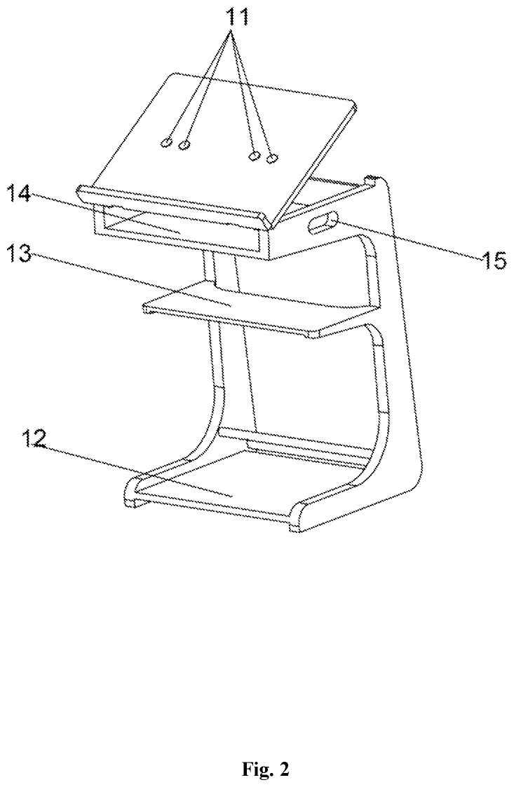

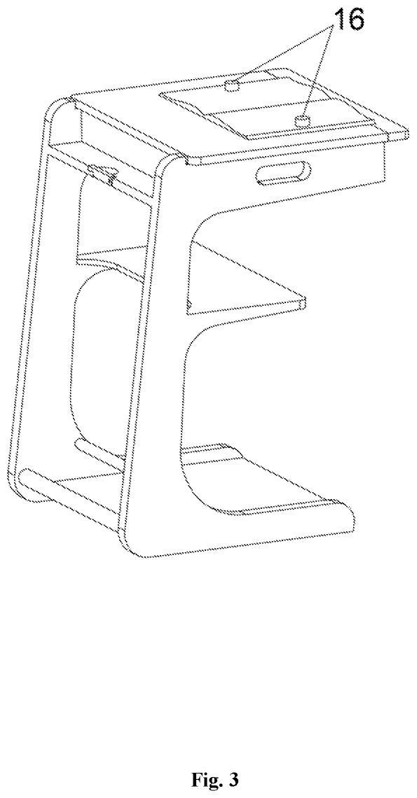

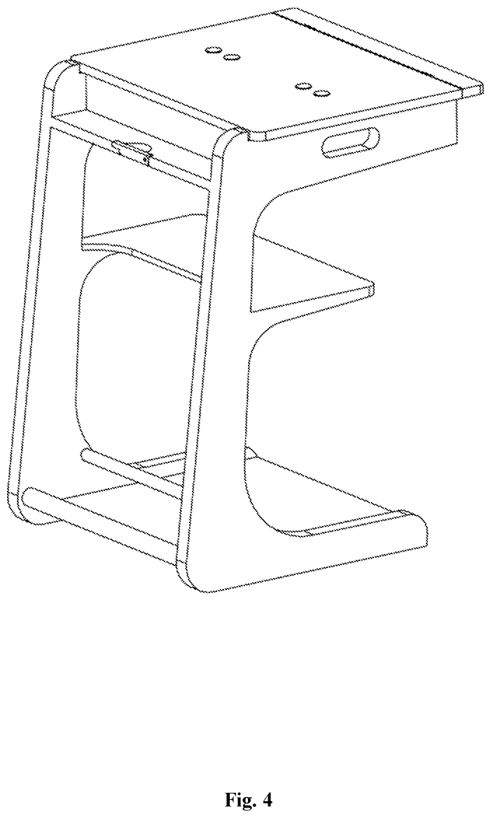

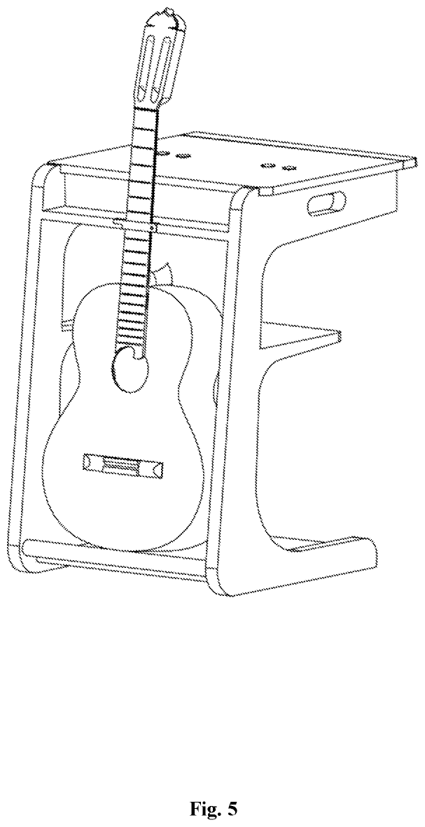

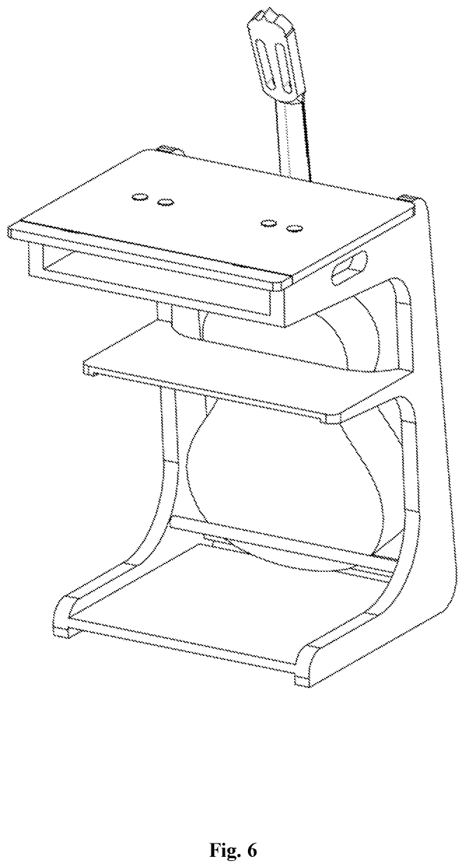

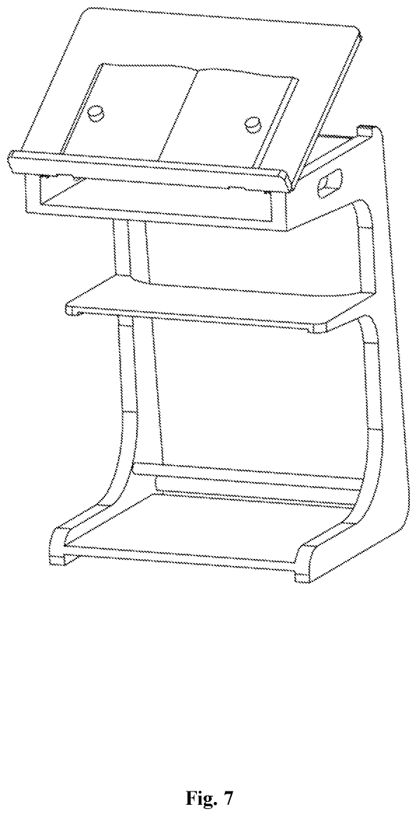

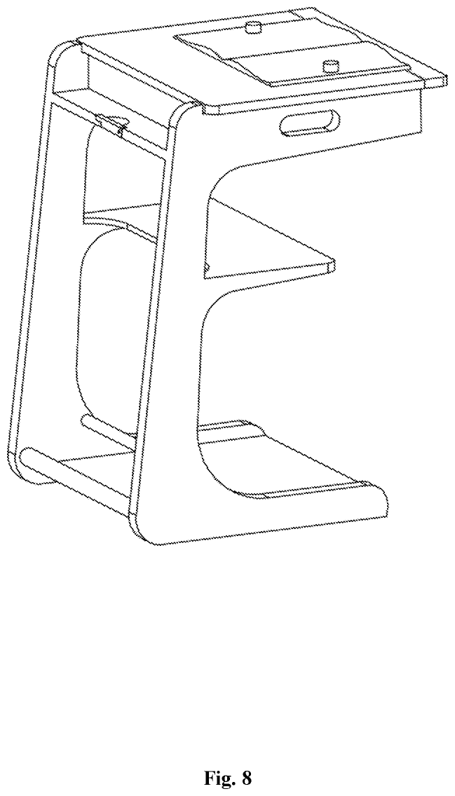

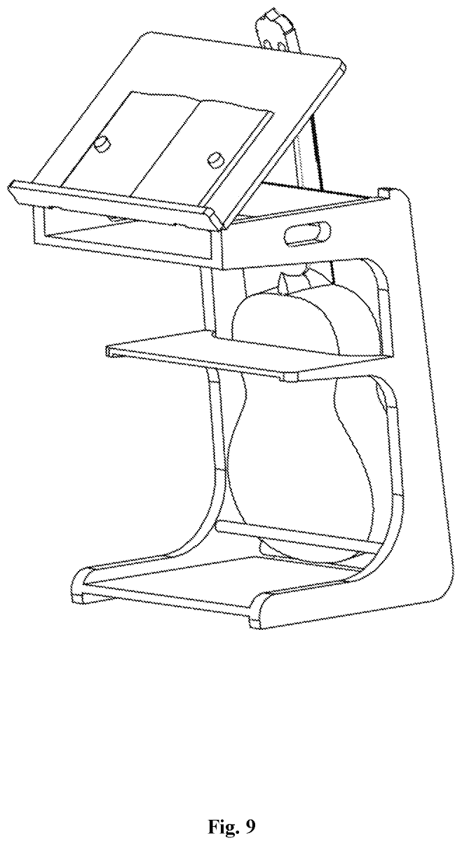

The present invention and implementations thereof will be described below with reference to the drawings. This description is not limiting, but the actual implementations are not limited thereto. If those skilled in the art are inspired, without departing from the creative aim of the present invention, all structural modes and embodiments similar to this technical solution designed without paying any creative effort shall fall into the protection scope the present invention.
Embodiment 1: As shown in FIGS. 5 and 6, a guitar accommodating portion 2 is arranged between the inner walls of two sides of the base body 1 of the guitar practice table, and a space in the guitar accommodating portion 2 is used to place a guitar. A guitar supporting rod 3 and a guitar limiting rod 4 are mounted between the inner walls of the base body. The guitar supporting rod 3 is used to support the bottom of the guitar, and the guitar limiting rod 4 is used to abut against the back of the guitar to prevent the backward slippage of the guitar. A neck placement groove 7 and a neck baffle 8 are arranged in an upper portion of the base body 1 to fix the neck of the guitar. When a user places a guitar, the bottom of the guitar is first placed on the guitar supporting rod 3, the back of the guitar abuts against the neck placement groove 7, and the neck baffle 8 is rotated about a neck baffle axis 9. The neck baffle 8 is laid flat, so that the neck can be fixed, and the guitar can be prevented from falling down due to the displacement of the neck. At this time, the guitar can be steadily placed in the guitar accommodating portion 2. When it is necessary to take out the guitar, the neck baffle 8 is rotated and opened, so that the guitar can be taken out from guitar accommodating portion 2.
Embodiment 2: As shown in FIGS. 7 and 8, a music score plate 5 is arranged on the top of the guitar practice table, and the music score plate 5 is connected to the base body 1 through a hinge 10. The music score plate 5 can be rotated or laid flat through the hinge 10. A music score baffle 6 is arranged on an edge of the music score plate 5, and the music score baffle 6 is connected to the music score plate through a hinge. The music score baffle 6 can be inclined or laid flat through the hinge. When the user places a music score on the music score plate 5 for viewing, the music score plate 5 can be inclined or laid flat as needed, to achieve a better viewing effect. When the music score plate 5 is in an inclined state, the article on the music score plate 5 is prevented from falling off. The music score baffle 6 can be rotated upright to support the article on the music score plate 5. When the user does not need the function of the music score plate 5, the music score plate 5 and the music score baffle 6 can be rotated and be laid flat. At this time, the guitar practice table can serve as a desk.
Embodiment 3: As shown in FIGS. 7 and 8, a number of magnets 11 are embedded into to the music score plate 5 of the guitar practice table. When the music score is placed on the music score plate 5, the music score is adsorbed above the magnets 11 by an external magnetic pressing block 16. The page on the music score plat can be pressed by using the principle of magnetic adsorption, so that the page is prevented from turning arbitrarily and affecting the user's viewing.
Embodiment 4: As shown in FIGS. 1-3, a bottom shelf 12, a middle shelf 13 and a top shelf 14 are mounted between the inner walls of two sides of the base body, and the three shelves can be used to place articles. Handle holes 15 are formed on two sides of the upper portion of the base body 1, so that it is convenient to carry the guitar practice table.

What is claimed is:

1. A multifunctional guitar practice table, comprising a base body (1), wherein an accommodating portion (2) is arranged between the inner walls of two sides of the base body (1), and a space in the accommodating portion (2) is used to place a guitar; a guitar supporting rod (3) and a guitar limiting rod (4) are mounted between the inner walls of two sides of the base body (1), the guitar supporting rod is used to support the bottom of the guitar, and the guitar limiting rod (4) is used to abut against the back of the guitar to limit the guitar; a neck placement groove (7) and a neck baffle (8) are arranged in an upper portion of the base body (1), the neck placement groove (7) is used to place the neck of the guitar, and the neck baffle (8) can rotate about a neck baffle axis (9), so that the neck baffle (8) is buckled on the neck placement groove (7) and can lock the neck of the guitar and prevent the displacement of the neck; and, a music score plate (5) is arranged in the upper portion of the base body (1), the music score plate (5) is connected to the top of the base body (1) through a hinge, the music score plate (5) can be used to place a music score and can be rotated and inclined to facilitate a user to view the music score from multiple angles, and the music score plate (5) can also be laid flat as a desk.

2. The multifunctional guitar practice table according to claim 1, wherein a music score baffle (6) is arranged on an edge of the music score plate (5), and the music score baffle (6) is connected to the music score plate (5) through a hinge; the music score baffle (6) can be turned over; and, when the music score baffle (5) is in an inclined state, the music score baffle (6) can be turned over to support an article on the music score plate (5).

3. The multifunctional guitar practice table according to claim 2, wherein a plurality of magnets (11) are embedded in the music score plate (5), and the magnets (11) are used in combination with an external magnetic pressing block (16); and, when the music score is placed on the music score plate (5), the magnetic pressing block (16) is placed on a page and mutually adsorbed with the magnetic block (11) under the page, so as to press the music score and prevent the page from turning.

4. The multifunctional guitar practice table according to claim 1, wherein a bottom shelf (12), a middle shelf (13) and a top shelf (14) are mounted between the inner walls of two sides of the base body (1), and the bottom shelf (12), the middle shelf (13) and the top shelf (14) are all used to place an article.

5. The multifunctional guitar practice table according to claim 1, wherein handle holes (15) are formed on two sides of the base body (1), and the handle holes (15) can be convenient for carrying the guitar practice table.
